(19) United States
(12) Patent Application Publication
(10) Pub. No.: US 2003/0154198 A1
(43) Pub. Date: Aug. 14, 2003

(54) Method that automatically calculates supplier scores and payable due dates by material delivery inspections

(76) Inventors: Hung-Liang Chiu, Taipei (TW); Yih-Wen Tsai, Taipei (TW)

Correspondence Address: BIRCH STEWART KOLASCH & BIRCH, PO BOX 747, FALLS CHURCH, VA, 22040-0747, US

(21) Appl. No.: 10/072,980

(22) Filed: Feb. 12, 2002

(51) Int. Cl. G06F 7/00

(52) U.S. Cl. 707/10

(57) ABSTRACT

A method that automatically calculates supplier/vendor scores and payable due dates by material delivery inspection is a system that combines material delivery and quality inspection. It utilizes a pre-determined formula through the Enterprise Resource Planning (ERP) server to calculate supplier/vendor scores and automatically announces the inspection score of supplier/vendor material delivery to further generate payable due dates uploaded to the enterprise end as the basis of the accommodation check period. It can synchronize respective facilities, reduce obstacles to communications, decrease a glut in the inventory of facilities, diminish the risk of purchasing materials from the enterprise end and increase the enterprise profits.

### BACKGROUND OF THE INVENTION

1. Field of the Invention

The invention relates to a management and control method of supplier/vendor material delivery. More specifically, the invention relates to a method applying to the quality inspection system of material delivery in the manufacturing industry that utilizes material delivery results to automatically calculate supplier/vendor scores and payable due dates.

2. Related Art

With most enterprises and product manufacturers there are many ways to increase profit margins, and managing costs is one of these ways. Management of material costs among cost categories is a matter of great interest to enterprises. To satisfy required product quantities by clients or end users, those enterprises and product manufacturers have to prepare sufficient materials for maintaining normal capacity of production. The inability to maintain sufficient stock inventory may cause the loss of potential commercial opportunities, cause an imbalance between supply and demand (disequilibrium), or reduce, even lose, market shares to those enterprises and product manufacturers. On the other hand, overstocking results in a hoard of cash funds, difficulties in circulating capital, an increase in management of costs, and the loss of margin profits from invisible risks of changeable product markets to those enterprises and product manufacturers.

Daily problems in the manufacturing industry include: what parts or components need to be purchased, how to plan production schedules after purchasing material items, how to arrange delivery of finished goods from production, how to manage excess/surplus stock, etc. For example, capacity forecasts and formal orders are not the same thing, and even a formal order can change without notice. Therefore, loss caused by stock-out or excess/surplus stock results from mistaken list making and incorrect materials preparation. Besides, mistakes are often made during the troublesome process of material inspection. Moreover, there are problems of human relationships involved in the monthly accounts payable process to further cause revenue imbalance of an enterprise.

Current Enterprise Resource Planning (ERP) still has the following drawbacks. Vendor/supplier scores from material delivery inspection are related to the payable due dates from the enterprise to suppliers/vendors, but an enterprise has the problem of managing quality control of material deliveries from vendors/suppliers. In addition, the enterprise cannot manage the blind spots of inspecting materials and supplier/vendor scores in a just, open and timely fashion. Moreover, with the large amount of manpower and time spent in registering and calculating vendor/supplier scores from material delivery inspection, mistakes are often made.

Hence, a method that automatically calculates supplier/vendor scores and payable due dates by material delivery inspection in the manufacturing industry has become a heavily focused subject.

### SUMMARY OF THE INVENTION

In view of the foregoing, the invention aims at resolving the preceding disadvantages by providing a method that automatically calculates vendor/supplier scores and payable due dates by material delivery inspection. The primary object is to manage and control the status of incoming material supplies in the facilities through the Enterprise Resource Planning (ERP) server. Moreover, it combines the following elements in the material delivery inspection system: checking tentative receiving orders to find out defective components and parts, keeping statistics, and processing material withdrawals/returns. The Enterprise Resource Planning (ERP) server then generates vendor/supplier scores from material delivering inspections to process payments to suppliers/vendors when calculating the duration of monthly payable due dates for suppliers/vendors. This automatic process can largely reduce the required manpower and maintain a safe level of inventory in facilities on the enterprise end. It also decreases the risk of purchasing materials and reduces glut in the stock center/inventory house to further achieve the goal of increasing profits.

The disclosed method that automatically calculates supplier/vendor scores and payable due dates through material delivery inspection at least consists of the following steps. Firstly, receiving at least one message of storing materials in a facility through the Enterprise Resource Planning (ERP), opening a tentative receiving order from a facility, calculating a payable due date of the supplier/vendor from the tentative receiving order through the Enterprise Resource Planning (ERP), and processing payment to the supplier/vendor from the enterprise.

The detailed features and technologies of the invention will be more readily apparent from the following description, which proceeds with reference to the accompanying drawings.

### BRIEF DESCRIPTION OF THE DRAWINGS

FIG. 1 is a schematic representation of automatically calculating supplier/vendor scores and payable due dates by material delivery inspection of the invention.

FIG. 2-a is a flowchart representation of automatically calculating supplier/vendor scores and payable due dates by material delivery inspection of the invention.

FIG. 2-b is a flowchart representation of automatically calculating supplier/vendor scores and payable due dates by material delivery inspection according to the invention.

FIG. 3-a is a table representation of automatically calculating supplier/vendor scores and payable due dates by material delivery inspection.

FIG. 3-b is a table representation of automatically calculating supplier/vendor scores and payable due dates by material delivery inspection according to the invention.

### DETAILED DESCRIPTION OF THE INVENTION

The invention proposes a method of automatically calculating supplier/vendor scores and payable due dates by material delivery inspection. In particular, the method, based on the advocacy of the up-to-date Business Process Re-Engineer (BPR), mainly aims at improving effective utilization and management of enterprise resources. Moreover, the Material Requirement Planning (MRP) mainly aims at efficient management of material related problems, re-engineering management of incoming materials inspection and the working process of accounts payable control to reduce the risk, to find ways of decreasing operation costs of an organization. Prior to introduction of the invention, some important steps in inventory management are described as follows.

First, a vendor delivers materials to the inventory system on an enterprise end based on a purchase order by an enterprise. The stock clerk of the inventory system then counts receiving materials, issues one tentative receiving order and proceeds with material inspection. Any abnormal components that are rejected in the inventory center/stock house are returned to suppliers/vendors. Afterwards, the inventory system distributes materials to production lines according to material picking orders and replenishment orders for productions. Moreover, the inventory system returns/withdraws materials to the inventory center/stock house when there is any over-picking order and withdrawal order, and removes odd-picking orders and obsolescence orders from the inventory system. Finally, all finished goods from productions are delivered to the inventory system, goods delivery orders are generated and finished goods are delivered to client ends for selling. Any rejects are returned to the inventory system with a material return order. The aforementioned indicates the important steps in inventory management. The disclosed invention aims at controlling the process of accounts payable after initial steps of material inspection while materials are delivered to the inventory system.

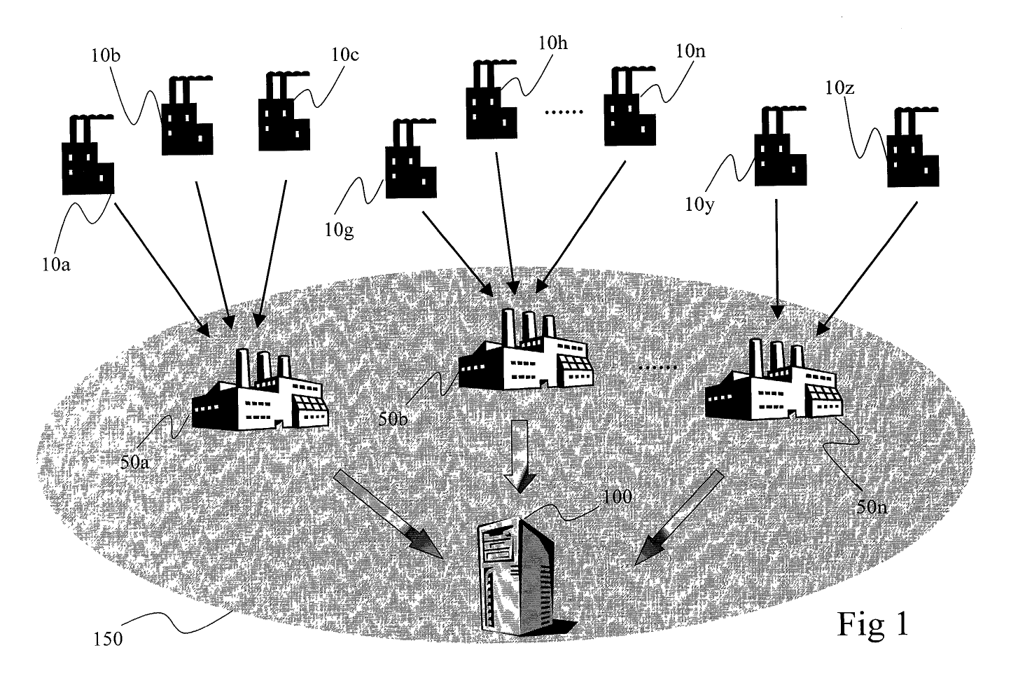

The feasibility and practicality of the invention will be elaborated by means of an embodiment depicted in the following. Refer to FIG. 1, which is a schematic representation of automatically calculating supplier/vendor scores and payable due dates by material delivery inspections of the invention. Details are further provided as follows:

First, The Enterprise Resource Planning (ERP) server 100 of an enterprise end integrates and controls all resources in the organization. Various facilities 50 on the enterprise end correspond to different suppliers/vendors 10 owing to respective goods from productions. As shown in FIG. 1, suppliers/vendors 10a, 10b, 10c, . . . etc. deliver materials to facility 50a, suppliers/vendors 10g, 10h˜n deliver materials to facility 50b, and suppliers/vendors 10y and 10z deliver materials to facility 50n. The respective facilities 50 process inspections upon receiving materials from suppliers/vendors 10. When there is any reject in the facilities, the facility 50 return it to the related supplier/vendors 10 and divide a tentative receiving order into a material inspection form and a material return form. Messages are centrally transferred back to the Enterprise Resource Planning (ERP) server 100 to make information public through the enterprise Intranet 150 to internally synchronize information for reducing obstacles to communications.

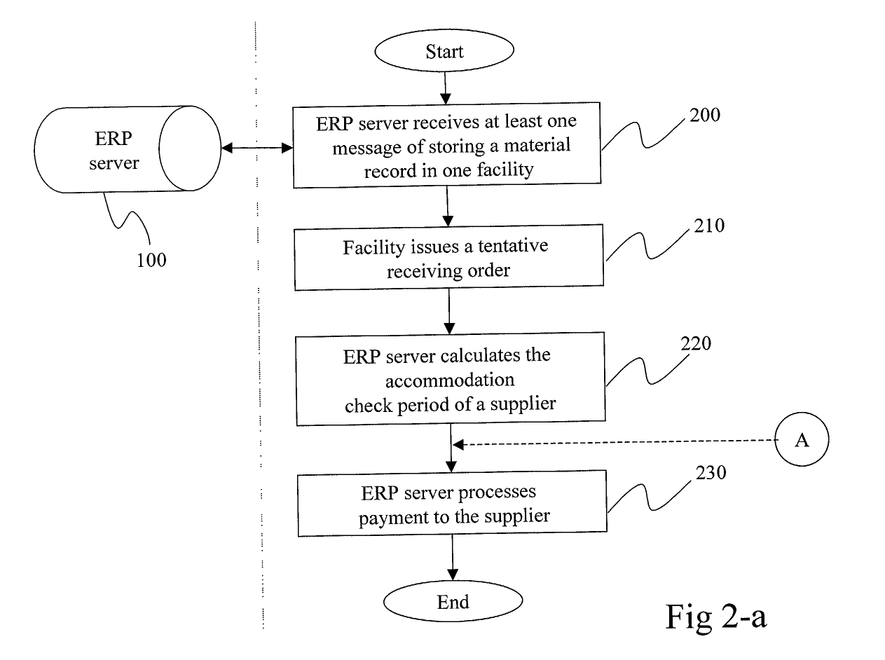

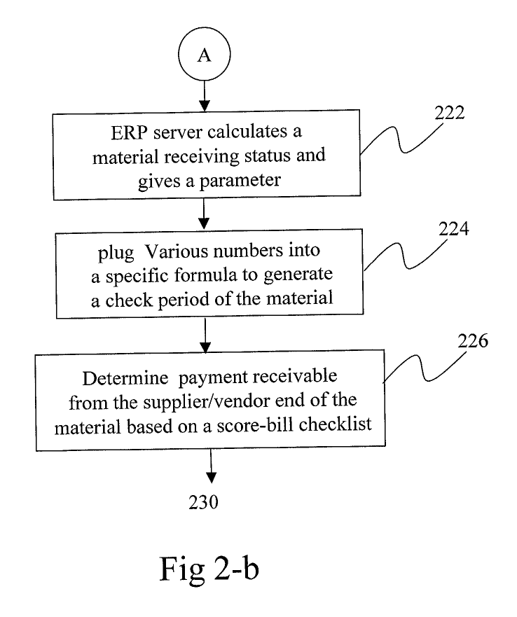

Refer to FIG. 2-a, which is a flowchart representation of automatically calculating supplier/vendor scores and payable due dates by material delivery inspections of the invention. Details are further provided as follows:

First, the Enterprise Resource Planning (ERP) server 100 receives at least one message of storing a material into a facility 50 (step 200). The facility 50, distinguished from respective product modules for production, executes receiving work orders of the enterprise end, while materials are distinguished from different attributes and staff. When a supplier/vendor 10 delivers material to a facility 50, the facility 50 issues a tentative receiving order according to received material (step 210). The tentative receiving order, which provides at least one column for recording all material numbers, is a receipt of total material amounts received from a supplier/vendor 10. The Enterprise Resource Planning (ERP) server 100 then calculates payable due date of the supplier/vendor 10 (step 220). Refer to process symbol A for details of calculating the payable due date of the supplier/vendor 10 from the tentative receiving order. Finally, the Enterprise Resource Planning (ERP) server 100 processes payment to the supplier/vendor 10 (step 230). It ends the process of the invention disclosed herein.

Process symbol A is shown in FIG. 2-b. Refer to FIG. 2-b, which is a flowchart representation of automatically calculating supplier/vendor scores and payable due dates by material delivery inspection of the invention. Details are further provided as follows:

First, the Enterprise Resource Planning (ERP) server 100 calculates the material receiving status and provides a parameter (step 222). The parameter is determined based on the difficulty in processing and can be rectified according to material receiving records of the supplier/vendor 10. When the parameter is set up, all numbers can be generated by a specified formula to come out as a score-bill checklist (step 224). When a score-bill checklist is generated, the due date of a payable check to the supplier/vendor 10 can be found corresponding to a score-bill checklist (step 226). The server further informs the accounting department of the enterprise end to process payment (step 223).

The aforementioned formula is to assess quality of material delivery from suppliers/vendors 10. The score result is from a base score minus a defect score. There are three variables on the specified formula:

1. rejects batches: the total amount of material withdrawn from the enterprise end back to the supplier/vendor 10 in one month.

2. Batches of special acceptance: the total amount of acceptable materials from the enterprise end back to the supplier/vendor 10 in one month.

3. delivery batches: the total amount of material accepted at the enterprise end in one month.

In addition, the enterprise end defines the base score, where the product of the defect score is equal to the multiplier of the above parameters and an inspection number. The inspection number is the sum of the rejects batches multiplied by 100 plus the product of batches of special acceptance multiplied by 40 and divided by the delivery batches.

The aforementioned score-bill checklist is defined by the enterprise to transfer the supplier/vendor score to the period of a check payable to the supplier/vendor. Moreover, the enterprise can utilize the score-bill checklist as supplier/vendor contract review base.

Effectiveness of the invention

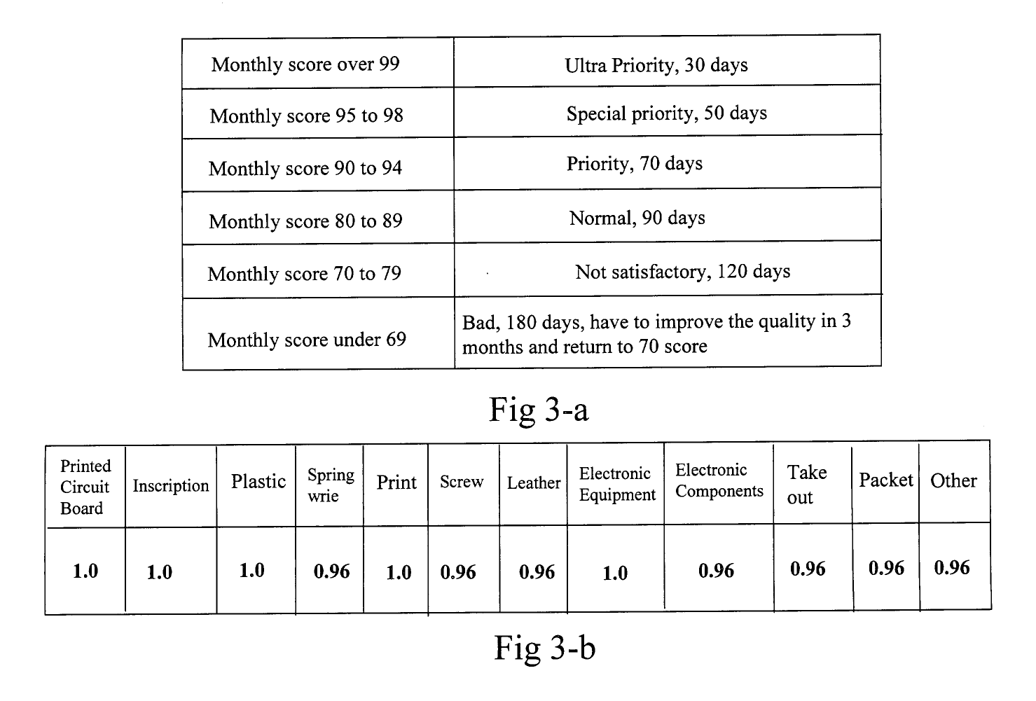

Refer to FIGS. 3-a and 3-b, which are representations of automatically calculating supplier/vendor scores and payable due dates by material delivery inspection. However prior to the introduction of FIGS. 3-a and 3-b, the main spirit of the disclosed invention is described as follows. The main spirit of the disclosed invention is to collect and determine the status of various received materials through a system and calculate the periods of checks payable and scores of suppliers/vendors based on collected data to achieve effective quality controls of material supply. In addition, it provides reasonable accommodation check periods to reduce costs of rejects paid by the enterprise. FIG. 3-a is an introduction to the score-bill checklist that explains various scores associated with respective accommodation check periods. Through the score-bill checklist, the enterprise can assess the quality of suppliers/vendors for awards and give demerits to poor suppliers/vendors , or even break off relations with poor suppliers/vendors. FIG. 3-b indicates the parameter standards mentioned in step 222. The parameters vary based upon the difficulty of the process of respective materials. The specific formula mentioned in the invention is: 100−{[(R×100+W×40)/N]×K}. R=rejects batches, N=batches of special acceptance, and K=difficulty of the process.

In the meantime, the feasibility of this formula will be elaborated by means of an example depicted in the following. In June 2001, supplier/vendor A delivers 1,000 batches of materials, in which there are 100 rejects batches, 700 acceptance batches, and 200 batches of special acceptance batches. The value K of the supplier/vendor is 0.96, so the score of the supplier/vendor in June is:

100−{[(100×100+200×40)/1000]×0.96}=82.72=83

According to FIG. 3-a, supplier/vendor A receives a 90 day accommodation check period in June.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. Automatically calculating supplier/vendor scores and payable due dates by material delivery inspection relates to a method applying to the quality inspection system of material supply in manufacturing industry. It proceeds the whole management and control of material supplies of the vendor ends through an Enterprise Resource Planning (ERP) server. Calculation through the Enterprise Resource Planning (ERP) server to timely handle material supply quality, reduce the risk of a glut in inventory. The disclosed method at least includes the following steps:
Receiving at least one message of storing at least one material in a facility through the Enterprise Resource Planning (ERP) server;
Issuing a receiving order by the facility according to received material;
Calculating the accommodation check period of the supplier/vendor based on the receiving order through the Enterprise Resource Planning (ERP) server; and
Proceeding payment from the enterprise end to the supplier/vendor end.

2. The invention as recited in claim 1, wherein the facility is categorized based on production requirements of different product prototypes to execute work orders received by the enterprise end.

3. The invention as recited in claim 1, wherein the material is categorized based on attributes of different materials.

4. The invention as recited in claim 1, wherein the receiving order is the receipt of total amounts of material supply acceptance from the vendor. It provides at least a column to store various numbers of the material records.

5. The invention as recited in claim 1, wherein the steps of calculating the accommodation check period of the supplier/vendor based on the receiving order through the Enterprise Resource Planning (ERP) server further includes the following steps,
Calculating receiving status of a material through the Enterprise Resource Planning (ERP) server and giving a parameter,
Utilizing various numbers in specific formula and generating score for accommodation check period of the material; and
Generating payable due date of the supplier/vendor according to a checklist.

6. The invention as recited in claim 5, wherein the parameter is determined by the difficulty of material process, and can be rectified based on material receiving reports from the supplier/vendor.

7. The invention as recited in claim 5, wherein specific formula is to assess material supply quality of the supplier/vendor through a base score deducts a defect score to generate result. It consists at least of the following variables:
A rejects batches : is the total amount of material returned from the enterprise end back to the supplier/vendor 10 in one month.
Batches of special acceptance : is the total amount of acceptable materials from the enterprise end back to the supplier/vendor 10 in one month.
Delivery batches: is the total amount of material acceptance at the enterprise end in one month.

8. The invention as recited in claim 7, wherein the base score is determined by the enterprise.

9. The invention as recited in claim 7, wherein the defect score is the product of the parameter multiplied by an inspecting number.

10. The invention as recited in claim 9, wherein the inspecting number is the result of multiplying the rejects batches by 100 add to the sum of multiplying the batches of special acceptance by 40 to divide the delivery batches.

11. The invention as recited in claim 5, wherein the score-bill checklist is determined by the enterprise. It is to transfer supplier/vendor scores to an accommodation check period and on the basis of contract renewal assessment through the Enterprise Resource Planning (ERP) server.
